(19) United States
(12) Patent Application Publication
(10) Pub. No.: US 2006/0274117 A1
(43) Pub. Date: Dec. 7, 2006

(54) Printhead unit and color inkjet printer having the same

(76) Inventors: Soo-hyun Kim, Suwon-si (KR); Min-ho Chun, Gwangmyeong-si (KR)

Correspondence Address: STANZIONE & KIM, LLP, 919 18TH STREET, N.W., SUITE 440, WASHINGTON, DC, 20006, US

(21) Appl. No.: 11/328,266

(22) Filed: Jan. 10, 2006

(30) Foreign Application Priority Data
Jun. 1, 2005 (KR) 2005-46737

(51) Int. Cl. B41J 2/16

(52) U.S. Cl. 347/47

(57) ABSTRACT

A printhead unit includes a plurality of printheads arranged in series in a direction in which a print paper proceeds, each of the printheads having a length greater than or equal to a width of the print paper. Each of the printheads includes a plurality of nozzle lines which eject ink having different colors, each of the nozzle lines including a plurality of nozzles arranged in a lengthwise direction of the printheads, the nozzles of each of the printheads are arranged not to align with one another in the direction in which the print paper proceeds, and the nozzles disposed on each of the nozzle lines of each of the printheads eject ink having a different color from ink ejected by the nozzles disposed on corresponding nozzle lines of the other printheads.

### CROSS-REFERENCE TO RELATED APPLICATIONS

This application claims the benefit under 35 U.S.C. § 119 of Korean Patent Application No. 2005-46737, filed on Jun. 1, 2005, in the Korean Intellectual Property Office, the disclosure of which is incorporated herein in its entirety by reference.

### BACKGROUND OF THE INVENTION

1. Field of the Invention

The present general inventive concept relates to an inkjet printer, and more particularly, to an inkjet printer which forms an image by ejecting ink onto a print paper without a printhead moving in the widthwise direction of the print paper.

2. Description of the Related Art

Conventionally, inkjet printers are mainly scan type printers which form an image by ejecting ink while a printhead reciprocates in a widthwise direction of a print paper. Recently, to increase printing speed, line printers have been widely developed which form an image while a printhead having a plurality of nozzles arranged in the widthwise direction of the print paper ejects ink.

FIG. 1 is a magnified plan view illustrating a part of a nozzle surface 11 of a printhead 10 of a conventional line printer. FIG. 2 is a view illustrating a white band B generated due to a defect in ejection by some nozzles of the conventional line printer.

Referring to FIG. 1, in the nozzle surface 11 of the printhead 10, a plurality of nozzle chips 15, each formed with a plurality of nozzles 17, are arranged in a direction Y that is the widthwise direction a print paper. The nozzles 17 eject ink of black (K), cyan (C), magenta (M), and yellow (Y) colors to form a color image. In detail, the nozzles 17 in a first nozzle line L1 that is located in a first row in a direction X in which the print paper proceeds eject black ink. The nozzles 17 in a second nozzle line L2 that is located in a second row in the direction X eject cyan ink. The nozzles 17 in a third nozzle line L3 that is located in a third row in the direction X eject magenta ink. The nozzles 17 in a fourth nozzle line L4 that is located in a fourth row in the direction X eject yellow ink.

The nozzles 17 in each of the nozzle chips 15 are arranged like a checkerboard such that the nozzles 17 at corresponding positions in each of the nozzle lines L1, L2, L3, and L4 are located to align with one another in the direction X. Accordingly, a noticeable defect, such as the white band B that is generated due to a failure of compensation for the defective ejection by some of the nozzles 17 may occur in an image. In detail, the white band B is generated as follows.

When a user inputs a print command to an inkjet printer to print an image in black only, only the nozzles 17 of the first nozzle line L1 eject ink to the print paper proceeding in the direction X to form the image. However, when a defective ejection occurs in one of the nozzles 17 in the first nozzle line L1, an undesired white line, that is, the white band B, is generated in the direction X on the print paper, as illustrated in FIG. 2.

Also, since the printhead 10 is fixed, a print resolution cannot be increased beyond a value that is determined by an interval between the adjacent nozzles 17 of the respective nozzle lines L1, L2, L3, and L4.

### SUMMARY OF THE INVENTION

The present general inventive concept provides a printhead unit having a plurality of printheads which prevent a defect of an image generated due to defective ejection by one or more nozzles of one of the printheads by allowing nozzles of another one of the print heads to eject ink to compensate for the malfunctioning printhead, and a color inkjet printer having the printhead unit.

The present general inventive concept also provides a printhead unit having a plurality of printheads which can increase a print resolution beyond a value determined by an interval between neighboring nozzles of the printheads, and a color inkjet printer having the printhead unit.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a printhead unit including a plurality of printheads arranged in series in a direction in which a print paper proceeds, each of the printheads having a length greater than or equal to a width of the print paper, each of the printheads including a plurality of nozzle lines which eject ink having different colors, each of the nozzle lines including a plurality of nozzles arranged in a lengthwise direction of the respective printheads, the nozzles of each of the printheads being arranged not to align with one another in the direction in which the print paper proceeds, and the nozzles disposed on each of the nozzle lines of each of the printheads eject ink having a different color from ink ejected by the nozzles disposed on corresponding nozzle lines of the other printheads.

Gaps between neighboring nozzles of each of the nozzle lines may be identical.

When the gap between each of the neighboring nozzles of each of the nozzle lines is G, and when the number of the nozzle lines is N, the nozzles located at corresponding positions of adjacent nozzle lines may be separated by G/N in the lengthwise direction of the printheads.

The plurality of printheads may include four printheads, each of the printheads may include four rows of nozzle lines, and each of the nozzle lines may eject one of cyan (C), magenta (M), yellow (Y), and black (K) ink.

Each of the printheads may further comprise a plurality of nozzle chips on which the plurality nozzle lines may be formed and which may be arranged on each of the printheads in the lengthwise direction of the printheads.

The nozzle chips may be arranged in a zigzag pattern.

The foregoing and/or other aspects of the present general inventive concept may also be achieved by providing a printhead unit to eject ink onto a printing medium proceeding therethrough, including a plurality of printheads, each having a length greater than or equal to a width of the printing medium and each comprising a plurality of nozzles to eject the ink onto the printing medium, the nozzles arranged such that none of the nozzles on the same printhead are aligned with each other in a proceeding direction of the printing medium, and each nozzle ejects a different color ink than the nozzles located at corresponding positions of different printheads.

The foregoing and/or other aspects of the present general inventive concept may also be achieved by providing a printhead unit to eject ink onto a printing paper proceeding therethrough, including a plurality of printheads each having a length greater than or equal to a width of the printing paper and each comprising a plurality of nozzle plates having a plurality of nozzles to eject ink onto the printing paper, the plurality of nozzles arranged on each nozzle plate in a plurality of rows extending in a lengthwise direction of the printheads and the nozzles in each row offset from each other such that the nozzles on each nozzle plate do not align with each other in a proceeding direction of the printing paper, and the plurality of nozzle plates arranged on each printhead such that the nozzles of different nozzle plates of the respective printhead do not align with each other in the proceeding direction of the printing paper.

The foregoing and/or other aspects of the present general inventive concept may also be achieved by providing a printhead unit comprising first, second, third, and fourth printheads, the first printhead comprising a plurality of first nozzles to eject a first color ink, a plurality of second nozzles to eject a second color ink, a plurality of third nozzles to eject a third color ink, and a plurality of fourth nozzles to eject a fourth color ink, the first nozzles are disposed on a first line extending in a lengthwise direction of the first printhead on which the second nozzles, the third nozzles, and the fourth nozzles are not disposed, and the first, second, third, and fourth nozzles arranged not to align with each other is a widthwise direction of the first printhead.

The foregoing and/or other aspects of the present general inventive concept may also be achieved by providing a color inkjet printer including a paper transfer unit to transfer a print paper in a direction, and a printhead unit to form a color image by ejecting ink onto the print paper, and including a plurality of printheads arranged in series in the direction in which the print paper is transferred, each of the printheads having a length greater than or equal to a width of the print paper, and each of the printheads including a plurality of nozzle lines which eject ink having different colors, each of the nozzle lines including a plurality of nozzles arranged in a lengthwise direction of the printhead, the nozzles of each of the printheads being arranged not to align with one another in the direction in which the print paper is transferred, and the nozzles disposed on each of the nozzle lines of each of the printheads eject ink having a different color from ink ejected by the nozzles formed on corresponding nozzle lines of the other printheads.

The foregoing and/or other aspects of the present general inventive concept may also be achieved by providing a color inkjet printer including a paper transfer unit to transfer a printing paper in a predetermined direction, a plurality of printheads each having a length greater than a width of the printing paper and each comprising a plurality of nozzles to eject ink onto the printing paper and grouped in a plurality of rows extending in a lengthwise direction of the printheads and offset from each other such that none of the nozzles align with each other in the direction in which the printing paper is transferred, and each of the nozzles ejects the same color ink as the other nozzles in the same row on the respective printhead and different color ink from the nozzles in the corresponding row on the different printheads, and a controller to control the plurality of printheads to eject the ink from the nozzles thereof to form an image on the printing paper.

The foregoing and/or other aspects of the present general inventive concept may also be achieved by providing a control method of a color inkjet printer having a plurality of printheads each having a length greater than width of a printing paper and each having a plurality of nozzles arranged such that none of the nozzles on the respective printhead are aligned with each other in a paper proceeding direction and each nozzle of each printhead ejects a different color ink from corresponding nozzles of different printheads, the method including ejecting ink the nozzles of the printheads to form a desired image on the printing paper, determining one of the nozzles to be defective, and compensating for the defective nozzle by controlling nozzles of the printheads other than that of the defective nozzle to eject ink instead of the defective nozzle.

The foregoing and/or other aspects of the present general inventive concept may also be achieved by providing a control method of an inkjet printer having a plurality of printheads each having a length greater than width of a printing paper and each having a plurality of nozzles arranged such that none of the nozzles on the respective printhead are aligned with each other in a paper proceeding direction, the method including selecting a number of the printheads to be used according to a desired image resolution, and ejecting ink through the nozzles of the selected number of printheads onto the printing paper to form an image having the desired image resolution.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a plan view illustrating a part of a nozzle surface of a printhead of a conventional line printer;

FIG. 2 is a view illustrating a white band generated due to a defective in ejection by some nozzles of a conventional line printer;

FIG. 3 is a sectional view illustrating a construction of a color inkjet printer according to an embodiment of the present general inventive concept;

FIG. 4 is a plan view illustrating nozzle surfaces of printheads of the color inkjet printer of FIG. 3;

FIG. 5 is a plan view illustrating nozzle patterns of nozzle chips located at corresponding positions in the printheads of the color inkjet printer of FIG. 3;

FIGS. 6 and 7 are views illustrating a method of compensating for an area where ink is not ejected when defective ejection occurs in one or more nozzles of a printhead unit according to an embodiment of the present general inventive concept; and

FIG. 8 is a view illustrating a method of increasing a resolution using the printhead unit according to an embodiment of the present general inventive concept.

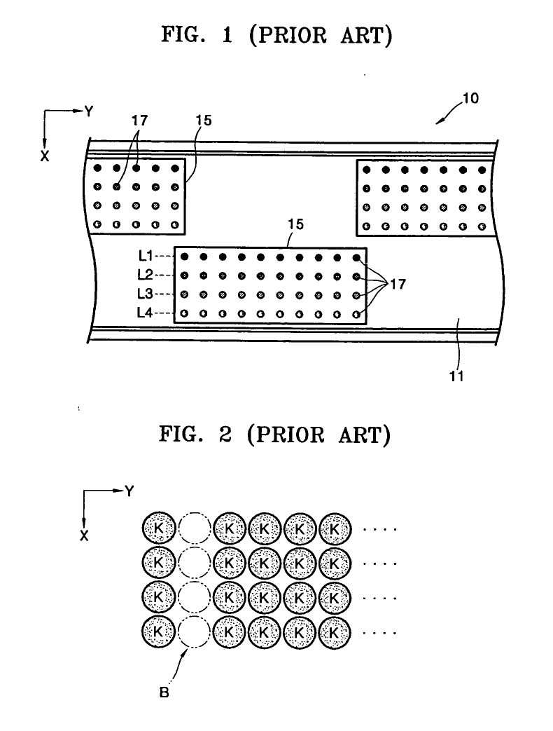

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

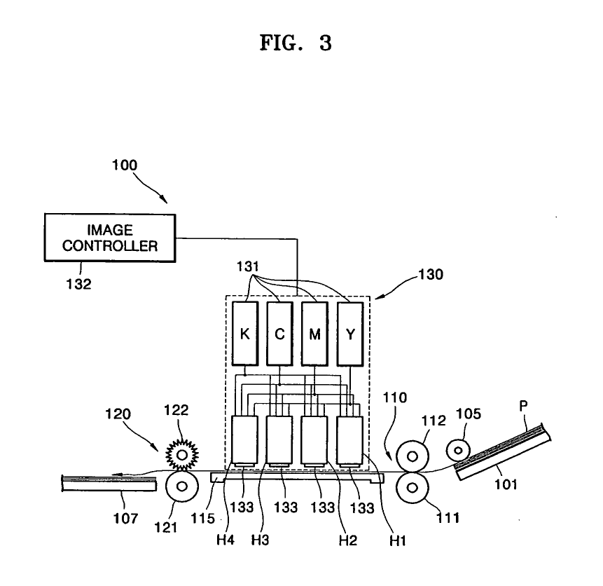

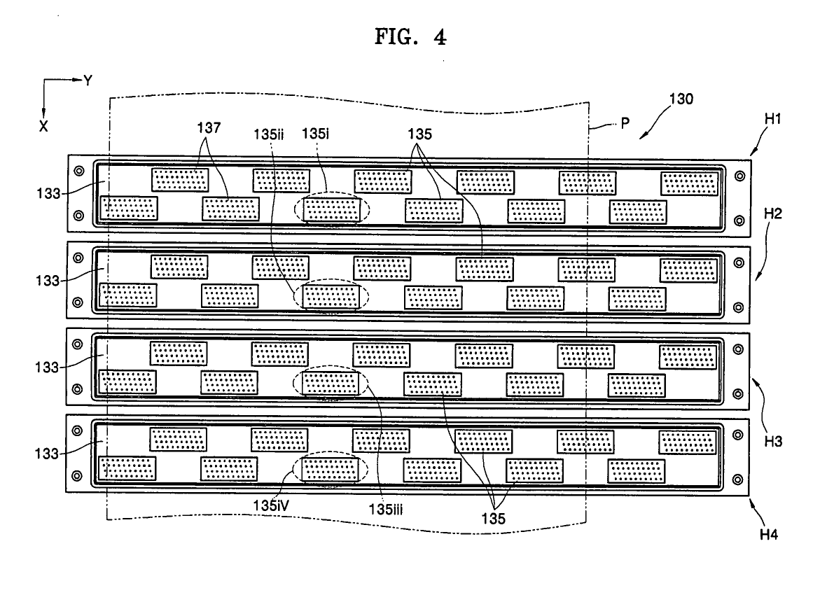

FIG. 3 illustrates a color inkjet printer 100 according to an embodiment of the present general inventive concept. Referring to FIG. 3, the color inkjet printer 100 includes a paper transfer unit to transfer a sheet of print paper P in a direction, and a printhead unit 130 to form a color image by ejecting ink onto the print paper P. The printhead unit 130 includes first, second, third, and fourth printheads H1, H2, H3, and H4 arranged in series in the direction in which the print paper P is transferred. Each of the printheads H1, H2, H3, and H4 has a length greater than or equal to the width of the print paper P. A plurality of nozzles 137 (refer to FIG. 4) to eject the ink onto the print paper P are formed on a nozzle surface 133 of each of the printheads H1, H2, H3, and H4. The nozzle surface 133 of each of the printheads H1, H2, H3, and H4 faces the print paper P when the print paper P is transferred by the paper transfer unit. In the color inkjet printer 100, the printheads H1, H2, H3, and H4 are fixed not to reciprocate in a widthwise direction of the print paper P and an image is formed in units of lines as the nozzles 137 eject the ink.

The printhead unit 130 includes four ink tanks 131 filled with black (K), cyan (C), magenta (M), and yellow (Y) inks. The ink tanks 131 are each connected to the printheads H1, H2, H3, and H4 so that black, cyan, magenta, and yellow inks are supplied to each of the printheads H1, H2, H3, and H4. The printhead unit 130 includes an image controller 132 to control ejection timing of the nozzles 137 to form the image on the print paper P.

The paper transfer unit includes a paper feed portion 110 located before the first printhead H1 in the direction in which the print paper P proceeds and a paper eject portion 120 located after the fourth printhead H4 in the direction in which the print paper P proceeds. The paper feed portion 110 includes a paper feed drive roller 111 driven by a motor (not shown) and a paper feed idle roller 112 arranged to face the paper feed drive roller 111 and rotated by friction. The paper eject portion 120 includes a paper eject drive roller 121 driven by a motor (not shown) and a star wheel 122 arranged to face the paper eject drive roller 121 to rotate with the paper eject drive roller 121. If the print paper P on which the image is formed is instantly pressed after the ink is ejected, the ink may smear causing a defect in the image. Accordingly, the star wheel 122 can be used in the paper eject portion 120 instead of an idle roller.

A paper platen 115 to support the print paper P to maintain a constant interval between the nozzle surface 133 and the print paper P is provided under the printheads H1, H2, H3, and H4. The paper transfer unit is not limited to the structure illustrated in FIG. 3 and a paper transfer unit having a transfer belt can alternatively be employed.

The color inkjet printer 100 further includes a paper feed plate 101 on which the print paper P is loaded and an auto sheet feeder (ASF) roller 105 to pick up and supply the print paper P loaded in the paper feed plate 101 to the paper feed portion 110 sheet by sheet. A paper eject plate 107 on which the print paper P with the image printed thereon is ejected by the paper eject portion 120 is further provided.

In the operation of the color inkjet printer 100, the print paper P loaded on the paper feed plate 101 is picked up by the ASF roller 105 and sequentially passes under the first printhead H1, the second printhead H2, the third printhead H3, and the fourth printhead H4. The nozzles 137 of the printheads H1, H2, H3, and H4 eject the ink onto the print paper P to form the image in a predetermined order according to a control signal of the image controller 132. The print paper P on which the image is formed is loaded on the paper eject plate 107 after passing through the paper eject portion 120.

FIG. 4 illustrates the nozzle surfaces 133 of the printheads H1, H2, H3, and H4 of FIG. 3. Referring to FIGS. 3 and 4, a plurality of nozzle chips 135 are arranged on the nozzle surface 133 of each of the printheads H1, H2, H3, and H4 in a lengthwise direction of the printheads H1, H2, H3, and H4 (the widthwise direction of the print paper P). The nozzles 137, which eject the ink, are arranged in the same pattern in each of the nozzle chips 135. Alternatively, a single nozzle chip formed with a plurality of nozzles arranged to correspond to the length of each of the printheads H1, H2, H3, and H4 can be installed on each nozzle surface 133. However, when a defective ejection occurs in some of the nozzles of the single nozzle chip, the entire nozzle chip needs to be replaced, which increases the cost of repairing the defect. Thus, as illustrated in FIG. 4, a method of arranging the nozzle chips 135 that are relatively smaller than the length of the printheads H1, H2, H3, and H4 can be used. Further, when a plurality of nozzle chips are arranged in series within a printhead, since an interval between the nozzles in a boundary area between the neighboring nozzle chips would be greater than an interval between the nozzles within each nozzle chip, an area where the ink cannot be ejected onto the print paper P may be formed. Thus, the nozzle chips 135 are arranged in a zigzag pattern, as illustrated in FIG. 4.

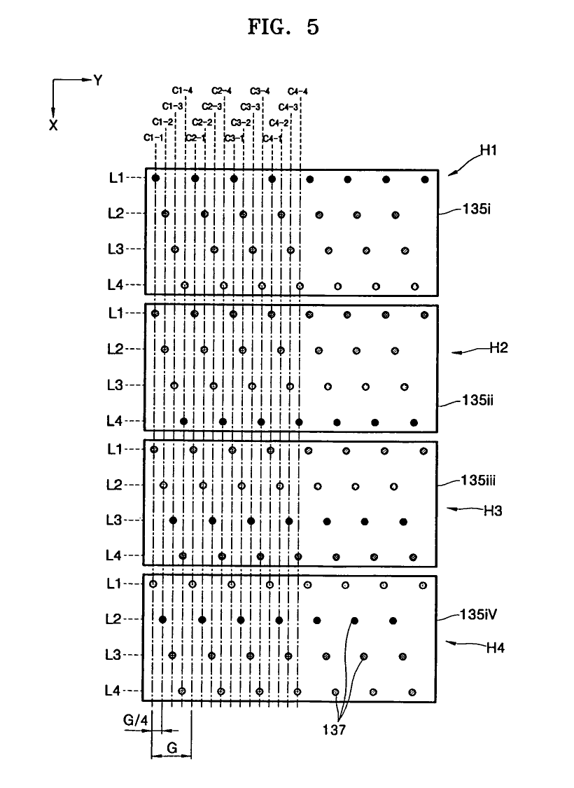

FIG. 5 illustrates the nozzle pattern of first, second, third, and fourth nozzle chips 135i, 135ii, 135iii, and 135iv located at corresponding positions in the first, second, third, and fourth printheads H1, H2, H3, and H4, respectively. Referring to FIGS.>4 and 5, first, second, third, and fourth nozzle lines L1, L2, L3, and L4, each having the nozzles 137, are provided in each of the nozzle chips 135i, 135ii, 135iii, and 135iv. The nozzle lines L1, L2, L3, and L4 are arranged in a direction X that is the direction in which the printing paper P proceeds and each of the nozzle lines L1, L2, L3, and L4 extends in a direction Y that is the lengthwise direction of the printheads H1, H2, H3, and H4.

The nozzles 137 formed in each of the nozzle chips 135i, 135ii, 135iii, and 135iv are arranged not to align with one another in the direction X. As illustrated in FIG. 5, a gap G between neighboring nozzles 137 in each of the nozzle lines L1, L2, L3, and L4 is identical for all neighboring nozzles 137 of each of the nozzle lines L1, L2, L3, and L4. That is, each nozzle 137 in each nozzle line L1, L2, L3 or L4 is separated from neighboring nozzles 137 in the same nozzle line L1, L2, L3, or L4 by the same gap G. When the number of the nozzle lines L1, L2, L3, and L4 provided in each of the nozzle chips 135i, 135ii, 135iii, and 135iv is N, a nozzle 137 located in a certain nozzle line L1, L2, L3, or L4 is separated by a value “G/N” in the direction Y from a nozzle 137 located in a corresponding position of an adjacent nozzle line L1, L2, L3 and L4.

As illustrated in FIG. 5, in each of the printheads H1, H2, H3, and H4, each of the nozzle lines L1, L2, L3, and L4 includes a first column group having first columns C1-1, C1-2, C1-3, and C1-4, a second column group having second columns C2-1, C2-2, C2-3, and C2-4, a third column group having third columns C3-1, C3-2, C3-3, and C3-4, a fourth column group having fourth columns C4-1, C4-2, C4-3, and C4-4, . . . , and an nth column group having nth columns Cn-1, Cn-2, Cn-3, and Cn-4. A gap between the nozzle 137 in the first column C1-1 of the first nozzle line L1 and the nozzle 137 in the second column C2-1 of the first nozzle line L1 is indicated as G. The gap G is an interval between the neighboring nozzles 137 in the same nozzle line L1. The gap G is identical for the neighboring nozzles 137 in the other nozzle lines L2, L3, and L4 as well. The Gap G can vary according to a resolution of 600 or 1200 dpi (dot per inch), but the present general inventive concept is not limited thereto.

Furthermore, in each of the printheads H1, H2, H3, and H4, the nozzle 137 located in the first column C1-1 of the first nozzle line L1, the nozzle 137 located in the first column C1-2 of the second nozzle line L2, the nozzle 137 located in the first column C1-3 of the third nozzle line L3, and the nozzle 137 located in the first column C1-4 of the fourth nozzle line L4 are located in corresponding positions to one another. The nozzle 137 located in the first column C1-2 of the second nozzle line L2 is separated by G/4 in the direction Y from the nozzle 137 located in the first column C1-1 of the first nozzle line L1. This relationship is established between nozzles 137 located in corresponding positions in adjacent nozzle lines L1, L2, L3, and L4 of each of the nozzle chips 135ii, 135iii, and 135iv. Accordingly, the nozzles 137 disposed on each of the nozzle lines L1, L2, L3, and L4 within each of the printheads H1, H2, H3, and H4 are arranged obliquely with respect to the direction X.

In the printhead unit 130, the nozzle line L1, L2, L3, or L4 of a printhead H1, H2, H3 or H4 and a corresponding nozzle line L1, L2, L3, or L4 of another printhead H1, H2, H3, or H4 eject ink having different colors, that is, eject different color ink. For example, as illustrated in FIG. 5, in the first printhead H1, the first nozzle line L1 ejects black ink, the second nozzle line L2 ejects cyan ink, the third nozzle line L3 ejects magenta ink, and the fourth nozzle line L4 ejects yellow ink. In the second printhead H2, the first nozzle line L1 ejects the cyan ink, the second nozzle line L2 ejects the magenta ink, the third nozzle line L3 ejects the yellow ink, and the fourth nozzle line L4 ejects the black ink. In the third printhead H3, the first nozzle line L1 ejects the magenta ink, the second nozzle line L2 ejects the yellow ink, the third nozzle line L3 ejects the black ink, and the fourth nozzle line L4 ejects the cyan ink. In the fourth printhead H4, the first nozzle line L1 ejects the yellow ink, the second nozzle line L2 ejects the black ink, the third nozzle line L3 ejects the cyan ink, and the fourth nozzle line L4 ejects the magenta ink.

Methods of compensating for defective ink ejection using the printhead unit 130 and a method of increasing a print resolution are described below according to various embodiments of the present general inventive concept.

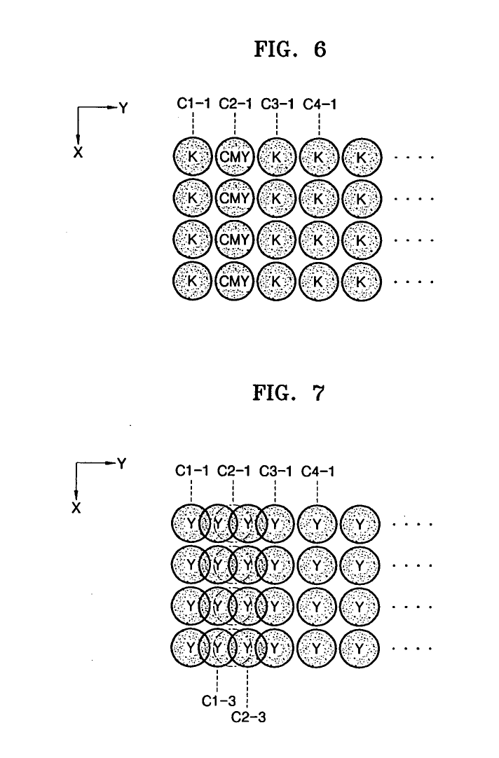

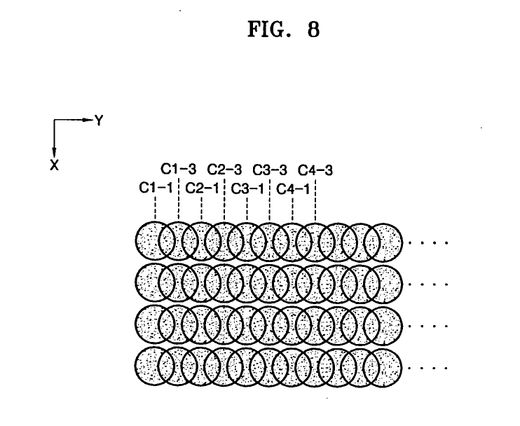

FIGS. 6 and 7 are views illustrating methods of compensating for an area where ink is not ejected when defective ejection occurs in some of the nozzles 137, using the printhead unit 130 according to embodiments of the present general inventive concept. FIG. 8 is a view illustrating a method of increasing a resolution using the printhead unit 130 according to another embodiment of the present general inventive concept.

FIG. 6 illustrates a method of compensating for the black color. Referring to FIGS. 3-6, the defective ejection occurs in the nozzle 137 located in the second column C2-1 of the first nozzle line L1 in the first printhead H1, and a user inputs a print command to the color inkjet printer 100 to print an image in black only. The image controller 132 detects a defect in the ejection of the ink from the nozzle 137 in the second column C2-1 of the first nozzle line L1 in the first printhead H1 and controls the nozzles 137 of other printheads H2, H3, and H4 located at the second column C2-1 of the first nozzle line L1 to eject ink. Accordingly, as illustrated in FIG. 6, cyan, magenta, and yellow ink are sequentially ejected from the nozzles 137 in the second column C2-1 of the first nozzle line L1 of the second printhead H2, the second column C2-1 of the first nozzle line L1 of the third printhead H3, and the second column C2-1 of the first nozzle line L1 of the fourth printhead H4, respectively, to the area in the second column C2-1 on the print paper P where the black ink is not printed due to the defect of the nozzle 137 located in the second column C2-1 of the first nozzle line L1 in the first printhead H1. As a result, the black color is compensated for at the same position on the print paper P by overlapping the other three colors.

FIG. 7 illustrates a method of compensating for the colors (C, M, or Y) other than black. As illustrated in FIG. 7, the defective ejection occurs in the nozzle 137 located in the second column C2-1 of the first nozzle line L1 in the fourth printhead H4, and a user inputs a print command to the color inkjet printer 100 to print an image in yellow only. The yellow color cannot be represented by overlapping the other colors, such as black, cyan, and magenta. Thus, when the defective ejection of the nozzle 137 in the second column C2-1 of the first nozzle line L1 of the fourth printhead H4 is detected, the image controller 132 controls the second printhead H2 so that the nozzles 137 located in the first and second columns C1-3 and C2-3 of the third nozzle line L3 of the second printhead H2 eject yellow ink. Accordingly, as illustrated in FIG. 7, the yellow ink is ejected to the positions in the first and second columns C1-3 and C2-3 of the third nozzle line L3 around the position in the second column C2-1 of the first nozzle line L1 on the print paper P where the yellow ink is supposed to be ejected through the defective nozzle 137 in the second column C2-1 of the first nozzle line L1 of the fourth printhead H4, instead of directly at the position in the second column C2-1 of the first nozzle line L1. Since the distribution of ink dots when there is no defective ejection in the nozzles and the distribution that compensates for the defective ejection as illustrated in FIG. 7 are difficult to discern with naked eyes, the user is not able to detect a change in print quality.

As illustrated in FIG. 7, a defect in the nozzle 137 located in the second column C2-1 of the first nozzle line L1 of the fourth printhead H4 is compensated for using the nozzles 137 located in the first and second columns C1-3 and C2-3 of the third nozzle line L3 of the second printhead H2, but the present general inventive concept is not limited thereto. Alternatively, the image controller 132 can control the first and the third printheads H1 and H3 so that the nozzle 137 located in the first column C1-4 of the fourth nozzle line L4 of the first printhead H1 and the nozzle 137 located in the second column C2-2 of the second nozzle line L2 of the third printhead H3 eject yellow ink. Accordingly, the yellow ink can be ejected to positions of the first column C1-4 of the fourth nozzle line L4 and the second column C2-2 of the second nozzle line L2 on the print paper, which surround the position of the defect located at the second column C2-1 of the first nozzle line L1.

FIG. 8 illustrates the method of increasing the print resolution. As illustrated in FIG. 8, it is assumed that the user inputs a command to print an image in black only to the color inkjet printer 100. When the user instructs the color inkjet printer 100 to print the image at a predetermined basic resolution, the image controller 132 of FIG. 3 controls the first printhead H1 so that only the nozzles 137 located in the first nozzle line L1 of the first printhead H1 eject ink. Accordingly, ink dots are formed only at positions in the columns C1-1, C2-1, C3-1, C4-1, and so forth, on the print paper P, corresponding to the nozzles 137 located in the first nozzle line L1.

When the user instructs the color inkjet printer 100 to print the image at a resolution double the predetermined basic resolution, the image controller 132 controls the first and third printheads H1 and H3 so that ink can be ejected from the nozzles 137 located in the first nozzle line L1 of the first printhead H1 and the nozzles 137 located in the third nozzle line L3 of the third printhead H3. Accordingly, as illustrated in FIG. 8, ink dots are formed on the print paper P at positions in the columns C1-1, C2-1, C3-1, C4-1, and so forth corresponding to the nozzles 137 located in the first nozzle line L1 of the first printhead H1 and at positions in the columns C1-3, C2-3, C3-3, C4-3, and so forth corresponding to the nozzles 137 located in the third nozzle line L3 of the third printhead H3. For example, when the predetermined basic resolution of the color inkjet printer 100 is 600 dpi, the resolution can be increased to 1200 dpi by ejecting ink from the first and third printheads H1 and H3. Accordingly, when the nozzles 137 of the second and fourth printheads H2 and H4 are also controlled to eject ink, the resolution can be increased to 2400 dpi.

As described above, in a printhead unit according to the present general inventive concept and a color inkjet printer having the same, when defective ejection occurs in some nozzles of a printhead, the deterioration of an image that can be identified with naked eyes can be prevented because nozzles of other printheads eject ink to compensate for the defective ejection. Also, although the color inkjet printer is a line printer having fixed printheads, the print resolution can be increased proportionally to an increase in the number of the printheads.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead unit comprising:
a plurality of printheads arranged in series in a direction in which a print paper proceeds, each of the printheads having a length greater than or equal to a width of the print paper, each of the printheads comprising:
a plurality of nozzle lines which eject ink having different colors, each of the nozzle lines comprising a plurality of nozzles are arranged in a lengthwise direction of the respective printheads, the nozzles of each of the printheads being arranged not to align with one another in the direction in which the print paper proceeds, and the nozzles disposed on each of the nozzle lines of each of the printheads eject ink having a different color from ink ejected by the nozzles disposed on corresponding nozzle lines of the other printheads.

2. The printhead unit as claimed in claim 1, wherein gaps between neighboring nozzles of each of the nozzle lines are identical.

3. The printhead unit as claimed in claim 2, wherein, when the gap between the neighboring nozzles of each of the nozzle lines is G, and when the number of the nozzle lines within each of the printheads is N, the nozzles located at corresponding positions of adjacent nozzle lines are separated by G/N in the lengthwise direction of the printheads.

4. The printhead unit as claimed in claim 1, wherein the plurality of printheads comprises four printheads, each of the printheads comprises four rows of nozzle lines, and each of the nozzle lines ejects one of cyan (C), magenta (M), yellow (Y), and black (K) ink.

5. The printhead unit as claimed in claim 1, wherein each of the printheads comprises a plurality of nozzle chips on which the plurality of nozzle lines are formed and which are arranged on each of the printheads in the lengthwise direction of the printheads.

6. The printhead unit as claimed in claim 5, wherein the nozzle chips are arranged in a zigzag pattern.

7. A printhead unit to eject ink onto a printing medium proceeding therethrough, comprising:
a plurality of printheads, each having a length greater than or equal to a width of the printing medium and each comprising a plurality of nozzles to eject the ink onto the printing medium, the nozzles arranged such that none of the nozzles on the same printhead are aligned with each other in a proceeding direction of the printing medium, and each nozzle ejects a different color ink than the nozzles located at corresponding positions of different printheads.

8. The printhead unit as claimed in claim 7, wherein the nozzles of each of the printheads are arranged to form a plurality of rows extending in a lengthwise direction of the printheads, and the nozzles in each of the plurality of rows eject ink of the same color.

9. The printhead unit as claimed in claim 8, wherein the number of the printheads is equal to the number of the rows of nozzles of each printhead.

10. The printhead unit as claimed in claim 8, wherein neighboring nozzles in one of the plurality of rows are spaced apart in the lengthwise direction of the printheads such that one nozzle of each of the other rows is disposed between the neighboring nozzles in the lengthwise direction of the printheads.

11. The printhead unit as claimed in claim 7, wherein the number of the printheads is equal to the number of different colors of ink ejected through the nozzles.

12. A printhead unit to eject ink onto a printing paper proceeding therethrough, comprising:
a plurality of printheads each having a length greater than or equal to a width of the printing paper and each comprising a plurality of nozzle plates having a plurality of nozzles to eject ink onto the printing paper, the plurality of nozzles arranged on each nozzle plate in a plurality of rows extending in a lengthwise direction of the printheads and the nozzles in each row offset from each other such that the nozzles on each nozzle plate do not align with each other in a proceeding direction of the printing paper, and the plurality of nozzle plates arranged on each printhead such that the nozzles of different nozzle plates of the respective printhead do not align with each other in the proceeding direction of the printing paper.

13. The printhead unit as claimed in claim 12, wherein each nozzle row of each nozzle plate ejects ink of a different color from the other nozzle rows of the respective nozzle plate.

14. The printhead unit as claimed in claim 13, wherein each nozzle row of each nozzle plate ejects ink of the same color as corresponding nozzle rows of the other nozzle plates on the same printhead.

15. The printhead unit as claimed in claim 14, wherein each nozzle row of each nozzle plate ejects ink of a different color from corresponding nozzle rows of the nozzle plates on the other printheads.

16. A printhead unit comprising:
first, second, third, and fourth printheads, the first printhead comprising a plurality of first nozzles to eject a first color ink, a plurality of second nozzles to eject a second color ink, a plurality of third nozzles to eject a third color ink, and a plurality of fourth nozzles to eject a fourth color ink, the first nozzles are disposed on a first line extending in a lengthwise direction of the first printhead on which the second nozzles, the third nozzles, and the fourth nozzles are not disposed, and the first, second, third, and fourth nozzles arranged not to align with each other is a widthwise direction of the first printhead.

17. The printhead unit as claimed in claim 16, wherein the second printhead comprises a plurality of the first nozzles, a plurality of the second nozzles, a plurality of the third nozzles, and a plurality of the fourth nozzles, and the first nozzles of the second printhead are disposed on a second line on which the first nozzles of the first printhead are not disposed.

18. The printhead unit as claimed in claim 17, wherein the third printhead comprises a plurality of the first nozzles, a plurality of the second nozzles, a plurality of the third nozzles, and a plurality of the fourth nozzles, and the first nozzles of the third printhead are disposed on a third line on which the first nozzles of the first and second printheads are not disposed.

19. The printhead unit as claimed in claim 18, wherein the fourth printhead comprises a plurality of the first nozzles, a plurality of the second nozzles, a plurality of the third nozzles, and a plurality of the fourth nozzles, and the first nozzles of the fourth printhead are disposed on a fourth line on which the first nozzles of the first, second, and third printheads are not disposed.

20. A color inkjet printer comprising:
a paper transfer unit to transfer a print paper in a direction; and
a printhead unit to form a color image by ejecting ink onto the print paper, and comprising a plurality of printheads arranged in series in the direction in which a print paper is transferred, each of the printheads having a length greater than or equal to a width of the print paper, each of the printheads comprising:
a plurality of nozzle lines which eject ink having different colors, each of the nozzle lines comprising a plurality of nozzles arranged in a lengthwise direction of the printhead, the nozzles of each of the printheads being arranged not to align with one another in the direction in which the print paper is transferred, and the nozzles disposed on each of the nozzle lines of each of the printheads eject ink having a different color from ink ejected by the nozzles disposed on corresponding nozzle lines of the other printheads.

21. The printer as claimed in claim 20, wherein gaps between neighboring nozzles of each of the nozzle lines are identical.

22. The printer as claimed in claim 21, wherein, when the gap between the neighboring nozzles of each of the nozzle lines is G, and when the number of rows of the nozzle lines is N, the nozzles located at corresponding positions of adjacent nozzle lines are separated by G/N in the lengthwise direction of the printheads.

23. The printer as claimed in claim 20, wherein the plurality of printheads comprises four printheads, each of the printheads comprises four rows of nozzle lines and each of the nozzle lines ejects one of cyan (C), magenta (M), yellow (Y), and black (K) ink.

24. The printer as claimed in claim 20, wherein each of the printheads comprises a plurality of nozzle chips on which the plurality of nozzle lines are formed and which are arranged on each of the printheads in the lengthwise direction of the printheads.

25. The printer as claimed in claim 24, wherein the nozzle chips are arranged in a zigzag pattern.

26. A color inkjet printer comprising:
a paper transfer unit to transfer a printing paper in a predetermined direction;
a plurality of printheads each having a length greater than a width of the printing paper and each comprising a plurality of nozzles to eject ink onto the printing paper and grouped in a plurality of rows extending in a lengthwise direction of the printheads and offset from each other such that none of the nozzles align with each other in the direction in which the printing paper is transferred, and each of the nozzles ejects the same color ink as the other nozzles in the same row on the respective printhead and different color ink from the nozzles in the corresponding row on the different printheads; and
a controller to control the plurality of printheads to eject the ink from the nozzles thereof to form an image on the printing paper.

27. The color inkjet printer as claimed in claim 26, wherein the controller senses a defective nozzle of one of the printheads and controls nozzles of the other printheads to compensate for the sensed defective nozzle.

28. The color inkjet printer as claimed in claim 27, wherein when the sensed defective nozzle ejects black ink, the controller controls each nozzle located at a position corresponding to the defective nozzle on the printheads other than that of the defective nozzle to eject ink onto the printing paper instead of the defective nozzle.

29. The color inkjet printer as claimed in claim 27, wherein when the sensed defective nozzle ejects ink of a color other than black, the controller controls the nozzles that eject the same color ink as the defective nozzle of the printheads other than that of the defective nozzle and are located at positions adjacent to a position of the defective nozzle in the lengthwise direction of the printheads to eject ink onto the printing paper instead of the defective nozzle.

30. The color inkjet printer as claimed in claim 26, wherein the controller selects a number of the printheads to use to form the image to control the resolution of the image.

31. The color inkjet printer as claimed in claim 30, wherein the resolution increases proportionally to the number of printheads used to form the image.

32. A control method of a color inkjet printer having a plurality of printheads each having a length greater than width of a printing paper and each having a plurality of nozzles arranged such that none of the nozzles on the respective printhead are aligned with each other in a paper proceeding direction and each nozzle of each printhead ejects a different color ink from corresponding nozzles of different printheads, the method comprising:
ejecting ink the nozzles of the printheads to form a desired image on the printing paper;
determining one of the nozzles to be defective; and
compensating for the defective nozzle by controlling nozzles of the printheads other than that of the defective nozzle to eject ink instead of the defective nozzle.

33. The method as claimed in claim 32, wherein when the defective nozzle ejects black ink, the compensating for the defective nozzle comprises:
controlling each of the nozzles located at a position corresponding to the defective nozzle on the printheads other than that of the defective nozzle to eject ink instead of the defective nozzle.

34. The method as claimed in claim 32, wherein when the defective nozzle ejects ink of a color other than black, the compensating for the defective nozzle comprises:
controlling nozzles that eject the same color ink as the defective nozzle of the printheads other than that of the defective nozzle and are located at positions adjacent to a position of the defective nozzle in the lengthwise direction of the printheads to eject ink onto the printing paper instead of the defective nozzle.

35. A control method of an inkjet printer having a plurality of printheads each having a length greater than width of a printing paper and each having a plurality of nozzles arranged such that none of the nozzles on the respective printhead are aligned with each other in a paper proceeding direction, the method comprising:
selecting a number of the printheads to be used according to a desired image resolution; and
ejecting ink through the nozzles of the selected number of printheads onto the printing paper to form an image having the desired image resolution.
